(19) United States
(12) Patent Application Publication
(10) Pub. No.: US 2025/0076689 A1
(43) Pub. Date: Mar. 6, 2025

(54) OPTICAL DEVICE, OPTICAL TRANSMITTER, OPTICAL RECEIVER, AND OPTICAL TRANSCEIVER

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 18/777,067

(22) Filed: Jul. 18, 2024

(30) Foreign Application Priority Data
Sep. 1, 2023 (JP) 2023-142267

(51) Int. Cl. G02F 1/01; G02B 6/287; G02B 6/42; G02B 6/43; G02F 1/21

(52) U.S. Cl. CPC G02F 1/0147; G02B 6/287; G02B 6/4215; G02B 6/4279; G02B 6/43; G02F 1/212

(57) ABSTRACT

An optical device includes a waveguide in which light is guided and that has electro-optical effect and thermo-optical effect, and a heater electrode that is arranged on one of side surfaces of the waveguide and that heats the waveguide. The optical device includes a parallel electrode that is arranged on the other of the side surfaces of the waveguide, that is electrically connected to the heater electrode, and that has high resistance as compared with the heater electrode.

### CROSS-REFERENCE TO RELATED APPLICATION

This application is based upon and claims the benefit of priority of the prior Japanese Patent Application No. 2023-142267, filed on Sep. 1, 2023, the entire contents of which are incorporated herein by reference.

### FIELD

The embodiments discussed herein are related to an optical device, an optical transmitter, an optical receiver, and an optical transceiver.

### BACKGROUND

A conventional optical modulator includes an optical waveguide provided on, for example, a substrate, and also includes signal electrode and ground electrodes that are arranged in the vicinity of the optical waveguide, and, when a voltage is applied to the signal electrodes, an electric field is generated in an interior of the optical waveguide, the refractive index of the optical waveguide varies due to the electric field that is present in the interior of the optical waveguide, and thus, the phase of light is changed. The optical waveguide constitutes a Mach-Zehnder interferometer, and an output level of light is changed due to a difference of the phase of pieces of light travelling through the optical waveguide.

The optical modulator is, for example, a Mach-Zehnder modulator. FIG. 21 is a schematic plan view illustrating one example of an optical modulator 200 that is conventionally used. The optical modulator 200 is constituted by, for example, a thin film Lithium Niobate (LN: LiNbO₃) chip. The optical modulator 200 includes a first input waveguide 201, a first branching portion 202, two second input waveguides 203, two second branching portions 204, four third input waveguides 205, and four third branching portions 206. The optical modulator 200 includes eight first waveguides 207, four radio frequency (RF) modulating units 208, four first direct current (DC) modulating units 209, and four first multiplexing portions 210. The optical modulator 200 includes four second waveguides 211, two second DC modulating units 212, two second multiplexing portions 213, and two first output waveguides 214. The optical modulator 200 includes a single polarization rotator (PR) 215, a single polarization beam combiner (PBC) 216, and a single second output waveguide 217.

The first input waveguide 201 is, for example, a LN waveguide that guides signal light. The first branching portion 202 branches the signal light received from the first input waveguide 201 into the two second input waveguides 203. Each of the second input waveguides 203 is, for example, a LN waveguide that guides the signal light received from the first branching portion 202. Each of the second branching portions 204 branches the signal light received from the associated second input waveguide 203 into two third input waveguides 205. Each of the third branching portions 206 branches the signal light received from the associated third input waveguide 205 into two first waveguides 207A included in the RF modulating unit 208.

The RF modulating unit 208 is a modulating unit that performs high-speed modulation on the signal light passing through each of the two first waveguides 207A. The RF modulating unit 208 includes the two first waveguide 207A (207) that are arranged in parallel, and a plurality of RF electrodes 221 that are arranged parallel to the two first waveguides 207A. The two first waveguides 207A are, LN waveguides. The RF electrode 221 includes two ground electrodes 221B each of which is arranged parallel to an outer side of the associated one of the two first waveguides 207A, and a single signal electrode 221A that is arranged parallel to the first waveguides 207A at a position between the two first waveguides 207A. In the case where a high-frequency signal having a band of, for example, several tens of gigahertz (GHz) is input to the signal electrode 221A, the RF modulating unit 208 is able to perform high-speed modulation on the signal light passing through the first waveguide 207A in accordance with the high-frequency signal.

The first DC modulating unit 209 includes two first waveguides 207B (207) that are arranged in parallel, and a plurality of heater electrodes 222 that are arranged in parallel on the two first waveguides 207B. The two first waveguides 207B are, for example, LN waveguides. The first DC modulating unit 209 is a modulating unit that connects the two first waveguides 207A included in the RF modulating unit 208 and the two first waveguides 207B included in the first DC modulating unit 209, and that modulates the signal light passing through the two first waveguides 207B included in the first DC modulating unit 209. When an electric current flows in each of the heater electrodes 222, the first DC modulating unit 209 heats the first waveguide 207B by the heat generated in the heater electrodes 222. As a result of this, the refractive index of the first waveguide 207B is changed due to the thermo-optical effect, so that it is possible to adjust the phase of the signal light passing through the first waveguide 207B. The first multiplexing portion 210 multiplexes the pieces of signal light received from the two first waveguides 207B included in the first DC modulating unit 209, and outputs the multiplexed signal light to the second waveguides 211.

The second DC modulating unit 212 includes the two second waveguides 211 that are arranged in parallel, and heater electrodes 223 that are arranged on the two second waveguides 211. The two second waveguides 211 are, for example, LN waveguides. The second DC modulating unit 212 is a modulating unit that connects the two first multiplexing portions 210 and the two second waveguides 211 included in the second DC modulating unit 212, and that modulates the signal light passing through each of the two second waveguides 211 included in the second DC modulating unit 212. When an electric current flows in each of the heater electrodes 223, the second DC modulating unit 212 heats the second waveguide 211 by the heat generated in the heater electrodes 223. As a result of this, the refractive index of the second waveguide 211 is changed due to the thermo-optical effect, so that it is possible to adjust the phase of the signal light passing through the second waveguide 211. The second DC modulating unit 212 modulates the signal light passing through the second waveguide 211, and outputs the modulated signal light to the second multiplexing portions 213. Each of the second multiplexing portions 213 multiplexes the pieces of modulated signal light received from the associated two second waveguides 211 included in the second DC modulating unit 212, and outputs the multiplexed signal light to the first output waveguide 214.

One of the second multiplexing portions 213 multiplexes the pieces of signal light received from the two second waveguides 211 that are included in one of the second DC modulating units 212, and outputs the multiplexed signal light to the PR 215 by way of the associated one of the first output waveguides 214. The other of the second multiplexing portions 213 multiplexes the pieces of signal light received from the two second waveguides 211 that are included in the other of the second DC modulating units 212, and outputs the multiplexed signal light to the PBC 216 by way of the other of the first output waveguides 214.

The PR 215 performs polarization rotation on the signal light received from one of the second multiplexing portions 213, and outputs the signal light that has been subjected to the polarization rotation to the PBC 216. The PBC 216 performs polarization division multiplexing on both of the signal light that has been subjected to the polarization rotation and that has been received from the PR 215 and the signal light that has been received from the other of the second multiplexing portions 213, and outputs the signal light that has been subjected to the polarization division multiplexing to the second output waveguide 217.

FIG. 22 is a cross-sectional schematic diagram of one example of a cross-sectional view taken along line A-A illustrated in FIG. 21. The cross-sectional part taken along line A-A corresponds to the RF modulating unit 208 included in the optical modulator. The RF modulating unit 208 illustrated in FIG. 22 includes a support substrate 231 made of Si or the like, a first buffer layer 232 that is formed on the support substrate 231, a thin film LN substrate 233 that is formed on the first buffer layer 23, and a second buffer layer 234 that is formed on the thin film LN substrate 233. The RF modulating unit 208 includes the RF electrode 221 that is formed on the second buffer layer 234. The thin film LN substrate 233 includes the first waveguide 207A that is a rib type waveguide made of a thin film having a convex shape protruding upward. The RF electrode 221 includes the signal electrode 221A, and a pair of the ground electrodes 221B. In addition, on the second buffer layer 234 disposed on a slab, the RF electrode 221 having a coplanar waveguide (CPW) structure, that is, the signal electrode 221A, and the pair of the ground electrodes 221B that sandwich the signal electrode 221A are arranged.

FIG. 23 is a cross-sectional schematic diagram of one example of a cross-sectional view taken along line B-B illustrated in FIG. 21. The cross-sectional part taken along line B-B is the first DC modulating unit 209 included in the optical modulator 200. The first DC modulating unit 209 illustrated in FIG. 23 includes the support substrate 231, the first buffer layer 232 that is formed on the support substrate 231, and the thin film LN substrate 233 that is formed on the first buffer layer 232. The first DC modulating unit 209 includes the second buffer layer 234 that is formed on the thin film LN substrate 233, and the heater electrodes 222 that are formed on the second buffer layer 234. The thin film LN substrate includes the first waveguide 207B that is a rib type waveguide made of a thin film having a convex shape protruding upward. In addition, the heater electrodes 222 are arranged on the second buffer layer 234 disposed on a rib of the first waveguide 207B. Moreover, the second DC modulating unit 212 also has substantially the same cross-sectional structure as the first DC modulating unit 209, and the heater electrodes 222 are arranged on the second buffer layer 234 that is disposed on the second waveguide 211.

Accordingly, the first DC modulating unit 209 is able to solve a problem of a DC drift by using the heater electrodes 222 instead of using the DC electrodes. This point is not limited to the first DC modulating unit 209, but, in also the second DC modulating unit 212, it is possible to obtain the same effect by using the heater electrodes 223 instead of using the DC electrodes.
Patent Document 1: Japanese Laid-open Patent Publication No. 2013-003442
Patent Document 2: International Publication Pamphlet No. WO 2022/091980
Patent Document 3: U.S. Pat. No. 10,394,059
Patent Document 4: Japanese National Publication of International Patent Application No. 2002-541516
Patent Document 5: Japanese Laid-open Patent Publication No. 2003-021815

However, in the first DC modulating unit 209, the heater electrodes 222 are disposed directly above the first waveguide 207A, so that the first waveguide 207A is located close to the heater electrode 222, some of light propagating through the first waveguide 207A is absorbed into the heater electrodes 222, and thus a loss of light occurs. In also the second DC modulating unit 212, the second waveguide 211 is located close to the heater electrodes 223, so that some of light propagating through the second waveguide 211 is absorbed into the heater electrode 223, and thus a loss of light occurs.

### SUMMARY

According to an aspect of an embodiment, an optical device includes a waveguide, a heater electrode and a parallel electrode. The waveguide in which light is guided has electro-optical effect and thermo-optical effect. The heater electrode is arranged on one of side surfaces of the waveguide and heats the waveguide. The parallel electrode is arranged on the other of the side surfaces of the waveguide. The parallel electrode is electrically connected to the heater electrode, and has high resistance as compared with the heater electrode.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic plan view illustrating one example of an optical modulator according to the present embodiment;

FIG. 2 is a cross-sectional schematic diagram of one example of a cross-sectional view taken along line A-A illustrated in FIG. 1;

FIG. 3 is a schematic plan view illustrating one example of a first DC modulating unit according to a first embodiment;

FIG. 4 is an explanation diagram illustrating one example of a relationship between a position of a heater electrode and electric potential;

FIG. 5 is a cross-sectional schematic diagram of one example of a cross-sectional view taken along line B-B illustrated in FIG. 3;

FIG. 6 is a cross-sectional schematic diagram of one example of a cross-sectional view taken along line C-C illustrated in FIG. 3;

FIG. 7 is a schematic plan view illustrating one example of a first DC modulating unit according to a second embodiment;

FIG. 8 is a cross-sectional schematic diagram of one example of a cross-sectional view taken along line B-B illustrated in FIG. 7;

FIG. 9 is a cross-sectional schematic diagram of one example of a cross-sectional view taken along line C-C illustrated in FIG. 7;

FIG. 10 is a schematic plan view illustrating one example of a first DC modulating unit according to a third embodiment;

FIG. 11 is a cross-sectional schematic diagram of one example of a cross-sectional view taken along line B-B illustrated in FIG. 10;

FIG. 12 is a cross-sectional schematic diagram of one example of a cross-sectional view taken along line C-C illustrated in FIG. 10;

FIG. 13 is a schematic plan view illustrating one example of a first DC modulating unit according to a fourth embodiment;

FIG. 14 is a cross-sectional schematic diagram of one example of a cross-sectional view taken along line B-B illustrated in FIG. 13;

FIG. 15 is an explanation diagram illustrating one example of an optical transceiver according to the present embodiment;

FIG. 16 is a schematic plan view illustrating one example of an optical modulator according to a comparative example;

FIG. 17 is a schematic plan view illustrating one example of a first DC modulating unit according to comparative example 1;

FIG. 18 is a cross-sectional schematic diagram of one example of a cross-sectional view taken along line B-B illustrated in FIG. 17;

FIG. 19 is a schematic plan view illustrating one example of a first DC modulating unit according to comparative example 2;

FIG. 20 is a cross-sectional schematic diagram of one example of a cross-sectional view taken along line B-B illustrated in FIG. 19;

FIG. 21 is a schematic plan view illustrating one example of an optical modulator that is conventionally used;

FIG. 22 is a cross-sectional schematic diagram of one example of a cross-sectional view taken along line A-A illustrated in FIG. 21; and

FIG. 23 is a cross-sectional schematic diagram of one example of a cross-sectional view taken along line B-B illustrated in FIG. 21.

### DESCRIPTION OF EMBODIMENTS

### Comparative Example 1

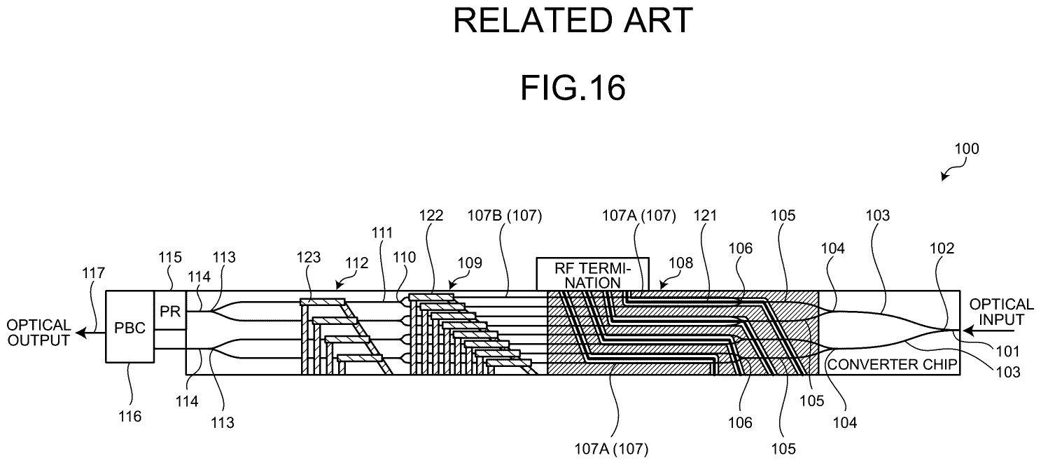

FIG. 16 is s schematic plan view illustrating one example of an optical modulator 100 according to a comparative example. The optical modulator 100 illustrated in FIG. 16 is constituted by, for example, a thin film Lithium Niobate (LN: LiNbO₃) chip. The optical modulator 100 includes a single first input waveguide 101, a single first branching portion 102, two second input waveguides 103, two second branching portions 104, four third input waveguides 105, and four third branching portions 106. The optical modulator 100 includes eight first waveguides 107, four radio frequency (RF) modulating units 108, four first direct current (DC) modulating units 109, and four first multiplexing portions 110. The optical modulator 100 includes four second waveguides 111, two second DC modulating units 112, two second multiplexing portions 113, and two first output waveguides 114. The optical modulator 100 includes a single polarization rotator (PR) 115, a single polarization beam combiner (PBC) 116, and a single second output waveguide 117.

The first input waveguide 101 is, for example, a LN waveguide that guides signal light. The first branching portion 102 branches the signal light received from the first input waveguide 101 into the two second input waveguides 103. Each of the second input waveguides 103 is, for example, a LN waveguide that guides the signal light received from the first branching portion 102. Each of the second branching portions 104 branches the signal light received from the associated second input waveguide 103 into two third input waveguides 105. Each of the third branching portions 106 branches the signal light received from the associated third input waveguides 105 into two first waveguides 107A (107) included in the RF modulating unit 108.

The RF modulating unit 108 is a modulating unit that performs high-speed modulation on the signal light passing through each of the two first waveguides 107A. The RF modulating unit 108 includes the two first waveguides 107A that are arranged in parallel, and a plurality of RF electrodes 121 that are arranged on the two first waveguides 107A in parallel. The two first waveguides 107A are, for example, LN waveguides. The RF electrode 121 includes two ground electrodes 121B that are arranged in parallel in an outer side of the associated one of the two first waveguides 107A, and a single signal electrode 121A that is arranged between the two first waveguides 107A so as to be parallel to the first waveguide 107A. In the case where a high-frequency signal having a band of, for example, several tens of gigahertz (GHz) is input to the signal electrode 121A, the RF modulating unit 108 is able to perform high-speed modulation on the signal light passing through the first waveguide 107A in accordance with a high-frequency signal.

A first DC modulating unit 109 includes two first waveguides 107B (107) that are arranged in parallel, and a plurality of heater electrodes 122 that are arranged in parallel on both side surfaces of the two first waveguides 107B. The two first waveguides 107B are, for example, LN waveguides. The first DC modulating unit 109 is a modulating unit that connects the two first waveguides 107A included in the RF modulating unit 108 and the two first waveguides 107B included in the first DC modulating unit 109, and that modulates the signal light passing through the two first waveguides 107B included in the first DC modulating unit 109. When an electric current flows in each of the heater electrodes 122, the first DC modulating unit 109 heats the first waveguide 107B by the heat generated in the heater electrodes 122. As a result of this, the refractive index of the first waveguide 107B is changed due to the thermo-optical effect, so that so that it is possible to adjust the phase of the signal light passing through the first waveguide 107B. The first multiplexing portion 110 multiplexes the pieces of signal light received from the two first waveguides 107B included in the first DC modulating unit 109, and outputs the multiplexed signal light to the second waveguide 111.

The second DC modulating unit 112 includes the two second waveguides 111 that are arranged in parallel, and heater electrodes 123 that are arranged on both side surfaces of the two second waveguides 111. The two second waveguides 111 are, for example, LN waveguides. The second DC modulating unit 112 is a modulating unit that connects the two first multiplexing portions 110 and the two second waveguides 111 included in the second DC modulating unit 112, and that modulates the signal light passing through each of the two second waveguides 111 included in the second DC modulating unit 112. When an electric current flows in each of the heater electrodes 123, the second DC modulating unit 112 heats the second waveguide 111 by the heat generated in the heater electrodes 123. As a result of this, the refractive index of the second waveguide 111 is changed due to the thermo-optical effect, so that it is possible to adjust the phase of the signal light passing through the second waveguide 111. The second DC modulating unit 112 modulates the signal light passing through the second waveguide 111, and outputs the modulated signal light to each of the second multiplexing portions 113. Each of the second multiplexing portions 113 multiplexes the modulated signal light received from the associated two second waveguides 111 included in the second DC modulating unit 112, and outputs the multiplexed signal light to the first output waveguide 114.

One of the second multiplexing portions 113 multiplexes the pieces of signal light received from the two second waveguides 111 that are included in one of the second DC modulating units 112, and outputs the multiplexed signal light to the PR 115 by way of the associated one of the first output waveguides 114. The other of the second multiplexing portions 113 multiplexes the pieces of signal light received from the two second waveguides 111 that are included in the other of the second DC modulating unit 112, and outputs the multiplexed signal light to the PBC 116 by way of the other of the first output waveguides 114.

The PR 115 performs polarization rotation on the signal light received from one of the second multiplexing portions 113, and outputs the signal light that has been subjected to the polarization rotation to the PBC 116. The PBC 116 performs polarization division multiplexing on both of the signal light that has been subjected to the polarization rotation and that has been received from the PR 115 and the signal light that has been received from the other of the second multiplexing portions 113, and outputs the signal light that has been subjected to the polarization division multiplexing to the second output waveguide 117.

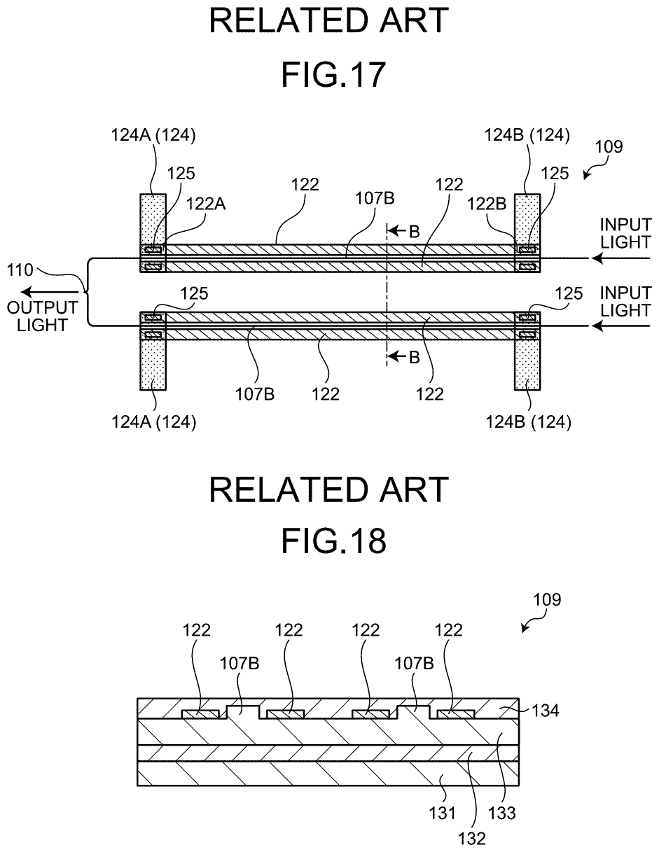

FIG. 17 is a schematic plan view illustrating one example of the first DC modulating unit 109 according to the comparative example 1. The first DC modulating unit 109 illustrated in FIG. 17 includes the two first waveguides 107B, the two heater electrodes 122 that are arranged in parallel on both sides of the first waveguide 107B, and two electrode pads 124 that are electrically connected to both ends of the heater electrode 122. The electrode pads 124 are constituted by an electrode material made of, for example, Au or the like. The electrode pad 124 includes a first electrode pad 124A that inputs an electric current, and a second electrode pad 124B that is a ground electrode. Each of the heater electrodes 122 electrically connects a portion between an input end 122A of the heater electrode 122 and the first electrode pad 124A by way of a via 125, and electrically connects a portion between an output end 122B of the heater electrode 122 and the second electrode pad 124B by way of the via 125. Then, in the heater electrode 122, an electric current received from the first electrode pad 124A flows in the second electrode pad 124B.

FIG. 18 is a cross-sectional schematic diagram of one example of a cross-sectional view taken along line B-B illustrated in FIG. 17. The cross-sectional part taken along line B-B is the first DC modulating unit 109 included in the optical modulator 100. The first DC modulating unit 109 illustrated in FIG. 18 includes a support substrate 131 made of Si or the like, a first buffer layer 132 that is formed on the support substrate 131, and a thin film LN substrate 133 that is formed on the first buffer layer 132. The first DC modulating unit 109 includes the heater electrodes 122 that are arranged parallel to the first waveguides 107B so as to sandwich both side surfaces of each of the first waveguides 107B that are disposed on the thin film LN substrate 133, and a second buffer layer 134 that is formed on the thin film LN substrate 133 and the heater electrodes 122. The thin film LN substrate 133 includes the first waveguides 107B each of which is a rib type waveguide made of a thin film having a convex shape protruding upward. Furthermore, the second DC modulating unit 112 also has substantially the same cross-sectional structure as the first DC modulating unit 109, and includes the heater electrodes 123 that are arranged parallel to the second waveguides 111 so as to sandwich both side surfaces of each of the second waveguides 111.

The RF modulating unit 108 includes the support substrate 131, the first buffer layer 132 that is formed on the support substrate 131, and a thin film LN substrate 133 that is formed on the first buffer layer 132. The RF modulating unit 108 includes the second buffer layer 134 that is formed on the thin film LN substrate 133, and the RF electrode 121 that is formed on the second buffer layer 134. The thin film LN substrate 133 includes the first waveguide 107A that is a rib type waveguide made of a thin film having a convex shape protruding upward. The RF electrode 121 includes the signal electrode 121A, and a pair of the ground electrodes 121B. In addition, on the second buffer layer 134 disposed on a slab, the RF electrode 121 having a coplanar waveguide (CPW) structure, that is, the signal electrode 121A, and the pair of the ground electrodes 121B that sandwich the signal electrode 121A are arranged.

In the first DC modulating unit 109 according to the comparative example 1, the heater electrodes 122 are arranged on both side surfaces of the first waveguide 107B, so that it is possible to suppress a loss of light by reducing an amount of some of light that propagates through the first waveguide 107B and that is absorbed into the heater electrodes 122. In also the second DC modulating unit 112, the heater electrodes 123 are arranged on both side surfaces of the second waveguide 111, so that it is possible to suppress a loss of light by reducing an amount of some of light that propagates through the second waveguide 111 and that is absorbed into the heater electrode 123.

However, in the first DC modulating unit 109 according to the comparative example 1, the heater electrodes 122 are arranged on both side surfaces of the first waveguide 107B, so that the heating efficiency with respect to the first waveguide 107B is reduced and electrical power consumption is increased. In also the second DC modulating unit 112, the heater electrodes 123 are arranged on both side surfaces of the second waveguide 111, the heating efficiency with respect to the second waveguide 111 is reduced and electrical power consumption is increased.

In addition, the heater electrodes 122 are used in the first DC modulating unit 109, the thin film LN substrate 133 having a smaller thermo-optical coefficient than a substrate that is made of Si is used, a waveguide length of the first waveguide 107B needs to be made sufficiently longer. In also the second DC modulating unit 112, the thin film LN substrate 133 having a smaller thermo-optical coefficient is used, a waveguide length of the second waveguide 111 needs to be made sufficiently longer.

### Comparative Example 2

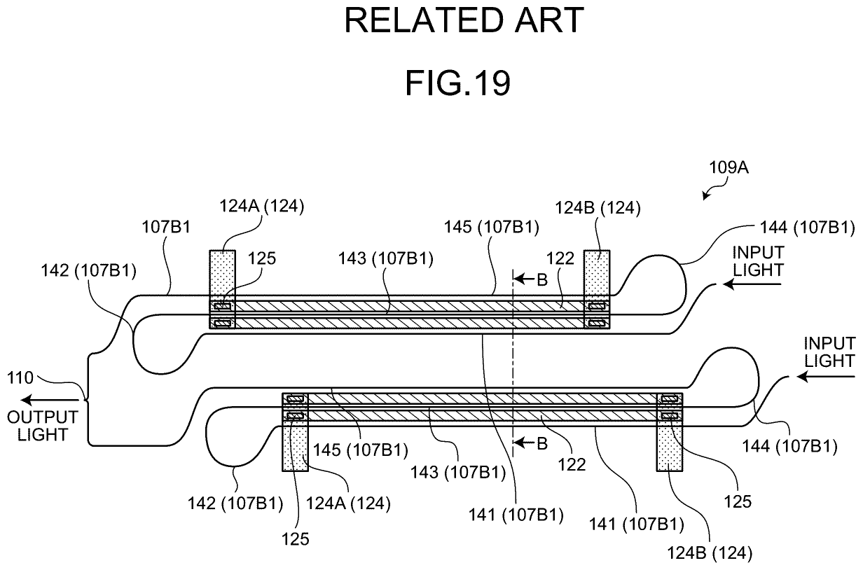

Accordingly, a DC modulating unit that improves the heating efficiency with respect to the waveguide will be described as comparative example 2. FIG. 19 is a schematic plan view illustrating one example of a first DC modulating unit 109A according to the comparative example 2. The first DC modulating unit 109A illustrated in FIG. 19 includes two first waveguides 107B1, the heater electrodes 122 that are arranged in parallel on a part of both side surfaces of the first waveguide 107B1, the two electrode pads 124 that are electrically connected to both ends of each of the heater electrodes 122. The electrode pad 124 includes the first electrode pad 124A in which an electric current is injected, and the second electrode pads 124B that are ground electrodes. The heater electrode 122 electrically connects a portion between the input end 122A of the heater electrode 122 and the first electrode pad 124A by way of the via 125, and electrically connects a portion between the output end 122B of the heater electrode 122 and the second electrode pad 124B by way of the via 125. Then, in the heater electrode 122, an electric current received from the first electrode pad 124A flows in the second electrode pad 124B.

The first waveguide 107B1 included in the first DC modulating unit 109A includes first inbound side waveguide 141, a first folded waveguide 142, an outbound side waveguide 143, a second folded waveguide 144, and a second inbound side waveguide 145. The first inbound side waveguide 141 is, for example, a first waveguide having a structure in which an input end of the first inbound side waveguide 141 is connected to an output end of the first waveguide 107A included in the RF modulating unit 108 and the output end of the first inbound side waveguide 141 is connected to an input end of the first folded waveguide 142. The first folded waveguide 142 has a structure in which an input end of the first folded waveguide 142 is connected to an output end of the first inbound side waveguide 141 and an output end of the first folded waveguide 142 is connected to an input end of the outbound side waveguide 143. The outbound side waveguide 143 is, for example, a third waveguide having a structure in which an input end of the outbound side waveguide 143 is connected to an output end of the first folded waveguide 142 and an output end of the outbound side waveguide 143 is connected to an input end of the second folded waveguide 144. The second folded waveguide 144 has a structure in which an input end of the second folded waveguide 144 is connected to an output end of the outbound side waveguide 143 and an output end of the second folded waveguide 144 is connected to an input end of the second inbound side waveguide 145. The second inbound side waveguide 145 is, for example, a second waveguide having a structure in which an input end of the second inbound side waveguide 145 is connected to an output end of the second folded waveguide 144 and an output end of the second inbound side waveguide 145 is connected to the first multiplexing portion 110. Furthermore, it is assumed that the first inbound side waveguide 141, the outbound side waveguide 143, and the second inbound side waveguide 145 are arranged in parallel.

The two heater electrodes 122 are arranged parallel to both of the first inbound side waveguide 141 and the second inbound side waveguide 145 so as to sandwich both side surfaces of the outbound side waveguide 143. Furthermore, one of the heater electrodes 122 is accordingly arranged parallel to one of the side surfaces of the first inbound side waveguide 141. Furthermore, the other of the heater electrodes 122 is accordingly arranged parallel to the other of the side surfaces of the second inbound side waveguide 145. The two heater electrodes 122 are electrically connected to the first electrode pad 124A by way of the via 125, and are electrically connected to the second electrode pad 124B by way of the via 125.

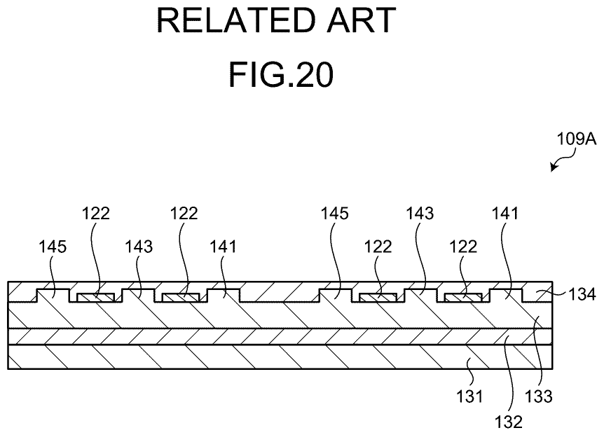

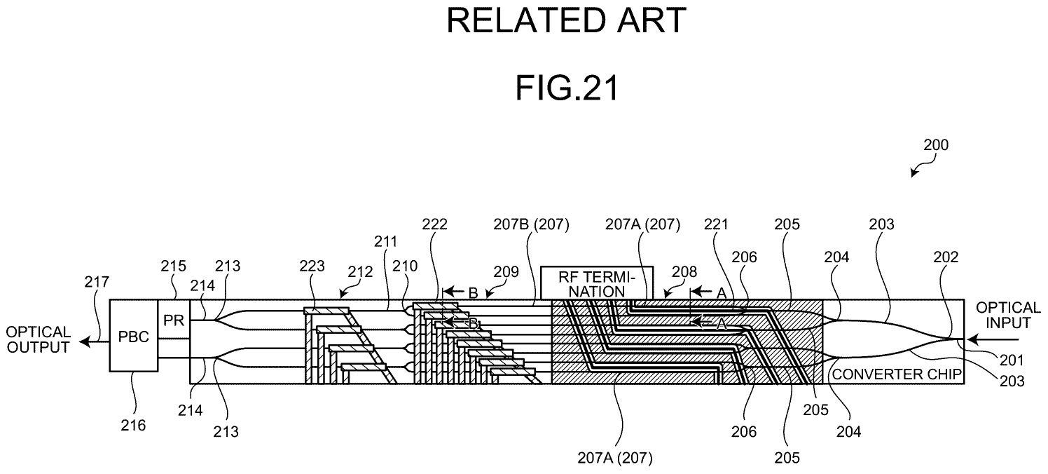

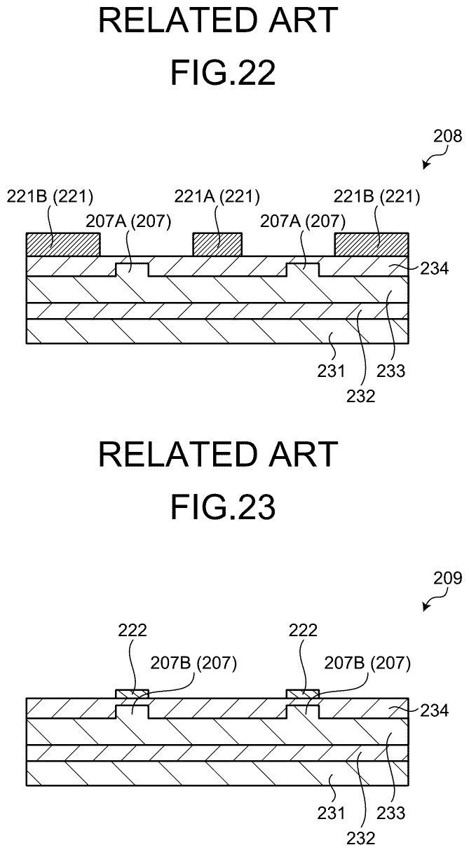

FIG. 20 is a cross-sectional schematic diagram of one example of a cross-sectional view taken along line B-B illustrated in FIG. 19. The cross-sectional part taken along B-B illustrated in FIG. 20 corresponds to the cross-sectional part of the first DC modulating unit 109A. The first DC modulating unit 109A illustrated in FIG. 20 includes the support substrate 131, a first buffer layer 132 that is formed on the support substrate 131, and a thin film LN substrate 133 that is formed on the first buffer layer 132. The first DC modulating unit 109A includes the heater electrodes 122 that are arranged parallel to the outbound side waveguide 143 so as to sandwich both side surfaces of the outbound side waveguide 143 included in the first waveguide 107B1 disposed on the thin film LN substrate 133. The first DC modulating unit 109A includes the second buffer layer 134 that is formed on the thin film LN substrate 133 and the heater electrodes 122. One of the heater electrodes 122 is accordingly arranged parallel to one of the side surfaces of the first inbound side waveguide 141. Furthermore, the other of the heater electrodes 122 is accordingly arranged parallel to the other of the side surfaces of the second inbound side waveguide 145.

A second DC modulating unit 112A also has substantially the same cross-sectional structure as the first DC modulating unit 109A. The second waveguide 111 included in the second DC modulating unit 112A also has the first inbound side waveguide 141, the first folded waveguide 142, the outbound side waveguide 143, the second folded waveguide 144, and the second inbound side waveguide 145. The second DC modulating unit 112A includes the heater electrodes that are arranged parallel to the outbound side waveguide 143 so as to sandwich both side surfaces of the outbound side waveguide 143 included in the second waveguide 111. One of the heater electrodes 123 is accordingly arranged parallel to one of the side surfaces of the first inbound side waveguide 141. Furthermore, the other of the heater electrodes 123 is accordingly arranged parallel to the other of the side surfaces of the second inbound side waveguide 145.

The first DC modulating unit 109A according to the comparative example 2 is constituted such that the first waveguide 107B1 has a folded structure and a waveguide length of the first waveguide 107B1 is made longer. As a result of this, as compared to a case of the first DC modulating unit 109 according to the comparative example 1, the first DC modulating unit 109A is able to ensure stable thermo-optical effect even when the thin film LN substrate 133. Furthermore, the first DC modulating unit 109A is constituted such that the heater electrodes 122 are arranged on both side surfaces of the outbound side waveguide 143 and the side surfaces of the first inbound side waveguide 141 and the second inbound side waveguide 145. As a result of this, the first DC modulating unit 109A is able to reduce the electrical power consumption by improving the heating efficiency of the first waveguide 107B1. The second DC modulating unit 112A according to the comparative example 2 is also constituted such that the second waveguide 111 has a folded structure and, in addition, a waveguide length of the second waveguide 111 is made longer. As a result of this, the first DC modulating unit 109A is able to reduce the electrical power consumption by improving the heating efficiency of the second waveguide 111 while ensuring stable thermo-optical effect as compared to a case of the second DC modulating unit 112A according to the comparative example 1.

However, in the first DC modulating unit 109A according to the comparative example 2, the heater electrodes 122 are arranged on one side surface of the first inbound side waveguide 141 and one side surface of the second inbound side waveguide 145. As a result of this, an electric field received from the heater electrode 122 is applied to both of the first inbound side waveguide 141 and the second inbound side waveguide 145, a DC drift occurs accordingly. In the first waveguide 107B1, an optical phase is changed caused by the DC drift as a result of the electro-optical effect being exhibited, so that stable phase control is not able to be implemented by the heater electrodes 122 as a result of unstable DC control. In also the first inbound side waveguide 141 and the second inbound side waveguide 145 included in the second DC modulating unit 112A, stable phase control is not able to be implemented due to occurrence of the DC drift.

Accordingly, an embodiment of an optical modulator including a DC modulating unit capable of implementing stable phase control performed by using heater electrodes will be described as an embodiment.

### (a) First Embodiment

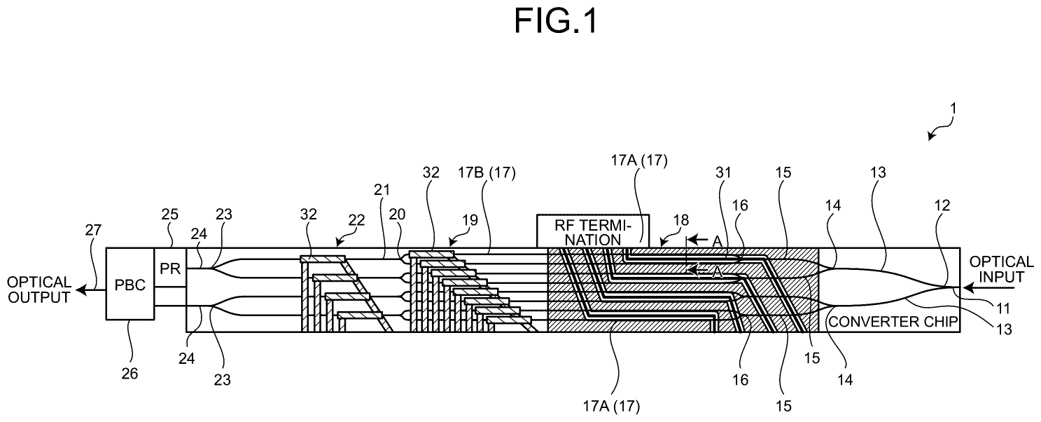

FIG. 1 is a schematic plan view illustrating one example of an optical modulator 1 according to the present embodiment. The optical modulator 1 illustrated in FIG. 1 is constituted by, for example, a thin film Lithium Niobate (LN: LiNbO₃) chip. The optical modulator 1 includes a single first input waveguide 11, a single first branching portion 12, two second input waveguides 13, two second branching portions 14, four third input waveguides 15, and four third branching portions 16. The optical modulator 1 includes eight first waveguides 17, four radio frequency (RF) modulating units 18, four first direct current (DC) modulating units 19, and four first multiplexing portions 20. The optical modulator 1 includes four second waveguides 21, two second DC modulating units 22, two second multiplexing portions 23, and two first output waveguides 24. The optical modulator includes a single polarization rotator (PR) 25, a single polarization beam combiner (PBC) 26, and a single second output waveguide 27.

The first input waveguide 11 is, for example, a LN waveguide that guides signal light. The first branching portion 12 branches the signal light received from the first input waveguide 11 into the two second input waveguides 13. Each of the second input waveguides 13 is, for example, a LN waveguide that guides the signal light received from the first branching portion 12. Each of the second branching portions 14 branches the signal light received from the associated second input waveguide 13 into the two third input waveguides 15. Each of the third branching portions 16 branches the signal light received from the associated third input waveguide 15 into two first waveguides 17A (17) included in the associated RF modulating unit 18.

The RF modulating unit 18 is a modulating unit that performs high-speed modulation on the signal light passing through each of the two first waveguides 17A. The RF modulating unit 18 includes the two first waveguides 17A that are arranged in parallel, and a plurality of RF electrodes 31 that are arranged parallel to the two first waveguides 17A. The two first waveguides 17A are, for example, LN waveguides. The RF electrode 31 includes two ground electrodes 31B each of which is arranged parallel to an outer side of the associated one of the first waveguides 17A, and a single signal electrode 31A that is arranged parallel to the first waveguide 17A at a position between the two first waveguides 17A. In the case where a high-frequency signal having a band of, for example, several tens of gigahertz (GHz) is input to the signal electrode 31A, the RF modulating unit 18 is able to perform high-speed modulation on the signal light passing through the first waveguide 17A in accordance with the high-frequency signal.

A first DC modulating unit 19 includes two first waveguides 17B, the two heater electrodes 32 that are arranged parallel to a part of the two first waveguides 17B, and two parallel electrodes 35 that are arranged parallel to the first waveguides 17B. The two first waveguides 17B are, for example, LN waveguides having the electro-optical effect and the thermo-optical effect. The first DC modulating unit 19 is a modulating unit that connects the two first waveguides 17A included in the RF modulating unit 18 and the two first waveguides 17B included in the first DC modulating unit 19, and that modulates the signal light passing through the two first waveguides 17B included in the first DC modulating unit 19. When an electric current flows in each of the heater electrodes 32, the first DC modulating unit 19 heats the first waveguide 17B by the heat generated in the heater electrodes 32. As a result of this, the refractive index of the first waveguide 17B is changed due to the thermo-optical effect, so that it is possible to adjust the phase of the signal light passing through the first waveguide 17B. The first multiplexing portion 20 multiplexes the pieces of signal light received from the two first waveguides 17B included in the first DC modulating unit 19, and outputs the multiplexed signal light to the second waveguide 21.

The second DC modulating unit 22 includes the two second waveguides 21, the heater electrodes 32 that are arranged on the two second waveguides 21, and the two parallel electrodes 35 that are arranged parallel to a part of the second waveguides 21. The two second waveguides 21 are, for example, LN waveguides having the electro-optical effect and the thermo-optical effect. The second DC modulating unit 22 is a modulating unit that connects the two first multiplexing portions 20 and the two second waveguides 21 included in the second DC modulating unit 22, and that modulates the signal light passing through each of the two second waveguides 21 included in the second DC modulating unit 22. When an electric current flows in each of the heater electrodes 32, the second DC modulating unit 22 heats the second waveguide 21 by the heat generated in the heater electrodes 32. As a result of this, the refractive index of the second waveguide 21 is changed due to the thermo-optical effect, so that it is possible to adjust the phase of the signal light passing through the second waveguide 21. The second DC modulating unit 22 modulates the signal light passing through the second waveguide 21, and outputs the modulated signal light to the second multiplexing portions 23. Each of the second multiplexing portions 23 multiplexes the pieces of modulated signal light received from the associated two second waveguides 21 included in the second DC modulating unit 22, and outputs the multiplexed signal light to the first output waveguide 24.

One of the second multiplexing portions 23 multiplexes the pieces of signal light received from the two second waveguides 21 that are included in one of the second DC modulating units 22, and outputs the multiplexed signal light to the PR 25 by way of the associated one of the first output waveguides 24. The other of the second multiplexing portions 23 multiplexes the pieces of signal light received from the two second waveguides 21 that are included in the other of the second DC modulating units 22, and outputs the multiplexed signal light to the PBC 26 by way of the other of the first output waveguides 24.

The PR 25 performs polarization rotation on the signal light received from one of the second multiplexing portions 23, and outputs the signal light that has been subjected to the polarization rotation to the PBC 26. The PBC 26 performs polarization division multiplexing on both of the signal light that has been subjected to the polarization rotation and that has been received from the PR 25 and the signal light that has been received from the other of the second multiplexing portions 23, and outputs the signal light that has been subjected to the polarization division multiplexing to the second output waveguide 27.

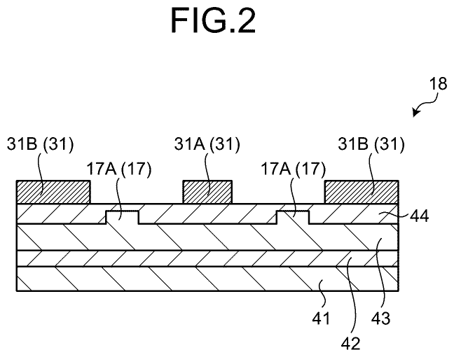

FIG. 2 is a cross-sectional schematic diagram of one example of a cross-sectional view taken along line A-A illustrated in FIG. 1. The RF modulating unit 18 illustrated in FIG. 2 includes a support substrate 41 that is made of Si or the like, a first buffer layer 42 that is formed on the support substrate 41, and a thin film LN substrate 43 that is formed on the first buffer layer 42. Furthermore, the RF modulating unit 18 includes a second buffer layer 44 that is formed on the thin film LN substrate 43, and the RF electrode 31 that is formed on the second buffer layer 44. The thin film LN substrate 43 includes a LN waveguide made of a thin film having a convex shape protruding upward. The LN waveguide is the first waveguide 17A (17) with a rib type waveguide that includes a rib and slabs that are formed on both sides of the rib. The RF electrode 31 includes the signal electrode 31A, and a pair of ground electrodes 31B. In addition, on the second buffer layer 44 disposed on the slab, the RF electrode 31 having a coplanar waveguide (CPW) structure, that is, the signal electrode 31A and a pair of the ground electrodes 31B that sandwich the signal electrode 31A are arranged.

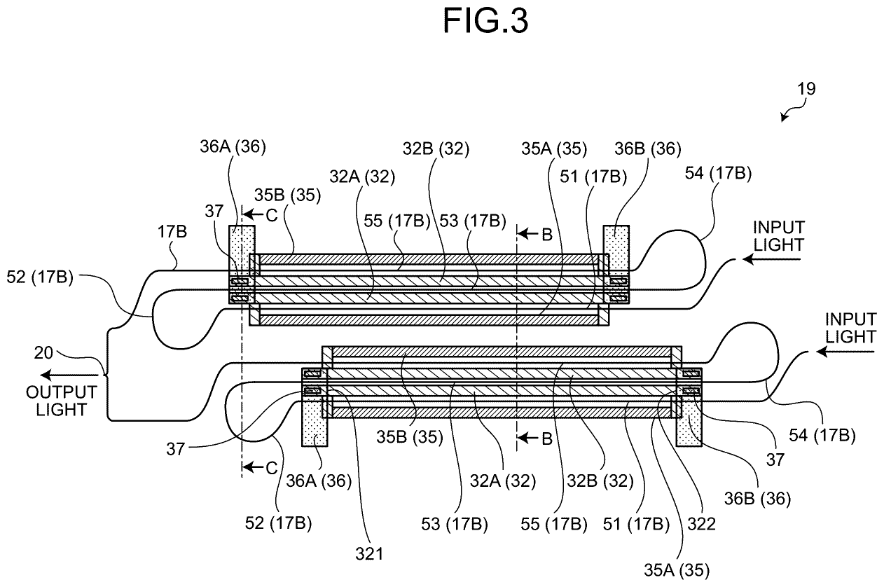

FIG. 3 is a schematic plan view illustrating one example of the first DC modulating unit 19 according to the first embodiment. The first DC modulating unit 19 illustrated in FIG. 3 includes the two first waveguides 17B (17), the two heater electrodes 32, the two parallel electrodes 35, and the two electrode pads 36. The heater electrode 32 is constituted by an electrode material including, for example, Ti, TiN, or the like. The heater electrode 32 includes a first heater electrode 32A and a second heater electrode 32B. Each of the electrode pads 36 is constituted by an electrode material made of, for example, Au, or the like. The electrode pad 36 is connected to the respective heater electrodes 32, and includes a first electrode pad 36A in which an electric current is injected into the heater electrode 32, and a second electrode pad 36B that connects the heater electrode 32 and a ground.

The heater electrode 32 electrically connects a portion between an input end 321 of the heater electrode 32 and the first electrode pad 36A by way of a via 37, and electrically connects a portion between an output end 322 of the heater electrode 32 and the second electrode pad 36B by way of the via 37. Then, the electric current received from the first electrode pad 36A flows in the second electrode pad 36B by the heater electrode 32. The input end 321 of the heater electrode 32 corresponds to an electrode region located in the vicinity of a region that is connected to the first electrode pad 36A in which an electric current is injected into the heater electrode 32, whereas the output end 322 of the heater electrode 32 is an electrode region located in the vicinity of a region that is connected to the second electrode pad 36B through which an electric current flows from the heater electrode 32.

The parallel electrode 35 is constituted by an electrode material having high resistance as compared with the heater electrode 32, that is, an electrode material including, for example, Si, doped Si, or the like. In other words, the heater electrode 32 is constituted to have a structure such that an electric current flows through the heater electrode 32 but less easily flows through the parallel electrode 35 and a voltage is accordingly applied to the heater electrode 32. The parallel electrode 35 electrically connects a portion between the input end of the parallel electrode 35 and the input end 321 of the heater electrode 32, and electrically connects a portion between the output end of the parallel electrode 35 and the output end 322 of the heater electrode 32.

The first waveguide 17B included in the first DC modulating unit 19 includes a first inbound side waveguide 51, a first folded waveguide 52, an outbound side waveguide 53, a second folded waveguide 54, and a second inbound side waveguide 55. The first inbound side waveguide 51 has a structure in which an input end of the first inbound side waveguide 51 is connected to an output end of the first waveguide 17A included in the RF modulating unit 18 and an output end of the first inbound side waveguide 51 is connected to an input end of the first folded waveguide 52. The first folded waveguide 52 has a structure in which an input end of the first folded waveguide 52 is connected to an output end of the first inbound side waveguide 51 and an output end of the first folded waveguide 52 is connected to an input end of the outbound side waveguide 53. The outbound side waveguide 53 has a structure in which an input end of the outbound side waveguide 53 is connected to an output end of the first folded waveguide 52 and an output end of the outbound side waveguide 53 is connected to an input end of the second folded waveguide 54. The second folded waveguide 54 has a structure in which an input end of the second folded waveguide 54 is connected to an output end of the outbound side waveguide 53 and an output end of the second folded waveguide 54 is connected to an input end of the second inbound side waveguide 55. The second inbound side waveguide 55 has a structure in which an input end of the second inbound side waveguide 55 is connected to an output end of the second folded waveguide 54 and an output end of the second inbound side waveguide 55 is connected to the first multiplexing portion 20. Furthermore, it is assumed that the first inbound side waveguide 51, the outbound side waveguide 53, and the second inbound side waveguide 55 are arranged in parallel.

The two heater electrodes 32 are arranged parallel to the outbound side waveguide 53 so as to sandwich both side surfaces of the outbound side waveguide 53. The first heater electrode 32A is accordingly arranged parallel to one of the side surfaces of the first inbound side waveguide 51. Furthermore, the second heater electrode 32B is accordingly arranged parallel to the other of the side surfaces of the second inbound side waveguide 55.

The two parallel electrodes 35 are arranged on the other of the side surfaces of the first inbound side waveguide 51, that is, arranged on the side surface opposite to the side surface on which the first heater electrode 32A is arranged, and are arranged on one of the side surfaces of the second inbound side waveguide 55, that is, arranged on the side surface opposite to the side surface on which the second heater electrode 32B is arranged. A first parallel electrode 35A is accordingly arranged on the other of the side surfaces of the first inbound side waveguide 51, that is, accordingly arranged parallel to the side surface opposite to the side surface on which the first heater electrode 32A is arranged. A second parallel electrode 35B is accordingly arranged on one of the side surfaces of the second inbound side waveguide 55, that is, accordingly arranged parallel to the side surface opposite to the side surface on which the second heater electrode 32B is arranged.

In other words, the first inbound side waveguide 51 is accordingly arranged parallel to both of the first heater electrode 32A and the first parallel electrode 35A such that the both side surfaces of the first inbound side waveguide 51 are sandwiched by the first heater electrode 32A and the first parallel electrode 35A. The second inbound side waveguide 55 is also accordingly arranged parallel to both of the second heater electrode 32B and the second parallel electrode 35B such that the both side surfaces of the second inbound side waveguide 55 are sandwiched by the second heater electrode 32B and the second parallel electrode 35B.

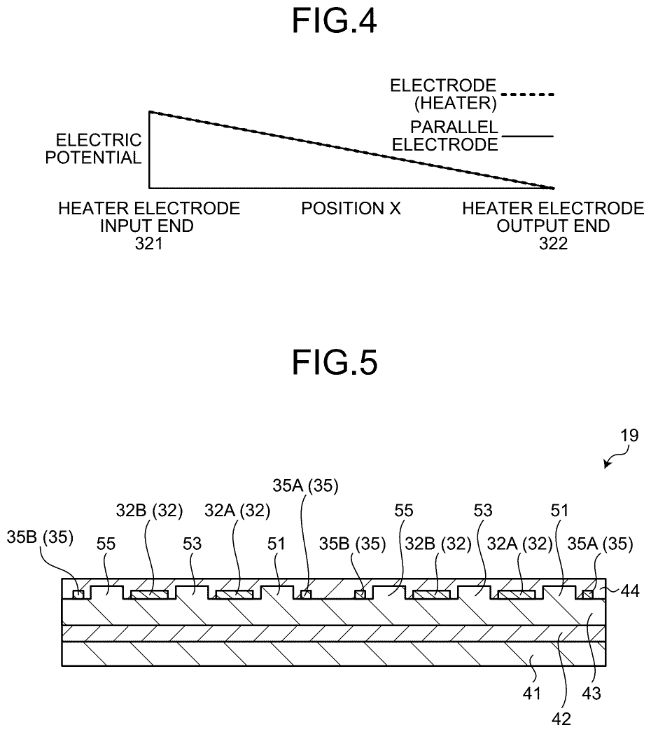

FIG. 4 is an explanation diagram illustrating one example of a relationship between a position of the heater electrode 32 and an electric potential. The electric potential at each of the positions X of the first heater electrode 32A disposed between the first electrode pad 36A and the second electrode pad 36B becomes the same as that of the first parallel electrode 35A. The position X is the position between the input end 321 and the output end 322 of the first heater electrode 32A. The electric potential at each of the positions X of the second heater electrode 32B between the first electrode pad 36A and the second electrode pad 36B becomes the same as that of the second parallel electrode 35B. The position X is the position between the input end 321 and the output end 322 of the second heater electrode 32B.

In the first inbound side waveguide 51, an electric current flows into the first heater electrode 32A that is located on one of the side surfaces, but an electric current less easily flows through the first parallel electrode 35A that is located on the other of the side surfaces, and the electric potential at the first heater electrode 32A and the electric potential at the first parallel electrode 35A are the same. As a result of this, it is possible to suppress a DC drift from occurring by suppressing the electric field from the first heater electrode 32A to the first inbound side waveguide 51.

In also the second inbound side waveguide 55, an electric current flows into the second heater electrode 32B that is located on one of the side surfaces, but an electric current less easily flows through the second parallel electrode 35B that is located on the other of the side surfaces, and the electric potential at the second heater electrode 32B and the electric potential at the second parallel electrode 35B are the same. As a result of this, it is possible to suppress a DC drift from occurring by suppressing the electric field from the second heater electrode 32B to the second inbound side waveguide 55.

FIG. 5 is a cross-sectional schematic diagram of one example of a cross-sectional view taken along line B-B illustrated in FIG. 4. The cross-sectional part taken along B-B illustrated in FIG. 5 is a cross-sectional part of the first DC modulating unit 19. The first DC modulating unit 19 includes the support substrate 41, the first buffer layer 42 that is formed on the support substrate 41, and the thin film LN substrate 43 that is formed on the first buffer layer 42. The first DC modulating unit 19 includes the two heater electrodes 32 that are arranged parallel to the outbound side waveguide 53 so as to sandwich both side surfaces of the outbound side waveguide 53 included in the first waveguide 17B disposed on the thin film LN substrate 43. The first DC modulating unit 19 includes the first parallel electrode 35A that is arranged parallel to the first inbound side waveguide 51 disposed on the thin film LN substrate 43, and the second parallel electrode 35B that is arranged parallel to the second inbound side waveguide 55 disposed on the thin film LN substrate 43. The first DC modulating unit 19 includes the thin film LN substrate 43, the heater electrode 32, the first parallel electrode 35A, and the second buffer layer 44 that is formed on the second parallel electrode 35B.

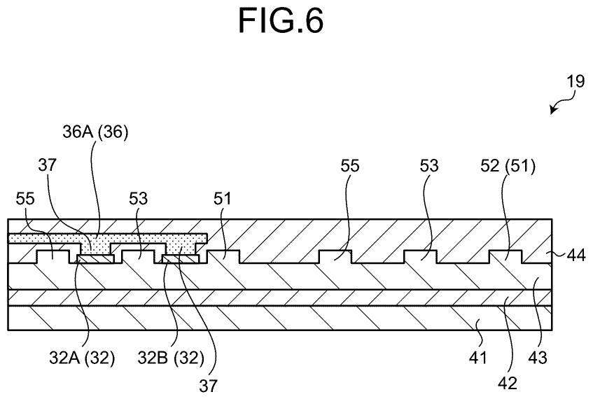

FIG. 6 is a cross-sectional schematic diagram of one example of a cross-sectional view taken along line C-C illustrated in FIG. 4. The first DC modulating unit 19 illustrated in FIG. 6 includes the first inbound side waveguide 51, the outbound side waveguide 53, and the second inbound side waveguide 55, in addition to the support substrate 41, the first buffer layer 42, the thin film LN substrate 43, and the second buffer layer 44. Furthermore, in the second buffer layer 44 included in the first DC modulating unit 19, the two heater electrodes 32 that are arranged parallel to the outbound side waveguide 53 so as to sandwich both side surfaces of the outbound side waveguide 53, and the via 37 that electrically connects the two heater electrodes 32 are included. Furthermore, in the second buffer layer 44, the first electrode pad 36A that is electrically connected to the via 37 is included.

The first DC modulating unit 19 includes the two heater electrodes 32 that are arranged parallel to both side surfaces of the outbound side waveguide 53, and the first parallel electrode 35A that is arranged parallel to the outer side of the first inbound side waveguide 51 that is arranged parallel to the outbound side waveguide 53. The first DC modulating unit 19 includes the second parallel electrode 35B that is arranged parallel to the outer side of the second inbound side waveguide 55 that is arranged parallel to the outbound side waveguide 53. As a result of this, even if a voltage is applied to the heater electrode 32, an electric field is not applied to the first waveguide 17B accordingly due to the first parallel electrode 35A and the second parallel electrode 35B. A DC drift does not occur as a result of an electric field not being applied to the first waveguide 17B, so that it is possible to implement stable phase control due to the heater electrode 32.

In addition, it is conceivable that the electrical power consumed by the heater electrode 32 is increased as a result of an electric current flowing in the first parallel electrode 35A and the second parallel electrode 35B. However, the electrode material of each of the first parallel electrode 35A and the second parallel electrode 35B is constituted to have high resistance as compared with the electrode material of the heater electrode 32. As a result of this, it is possible to suppress an increase in electric power to drive the heater electrode 32 while suppressing the electrical power consumed by the parallel electrode 35.

The second DC modulating unit 22 also has substantially the same cross-sectional structure as the first DC modulating unit 19. The second waveguide 21 included in the second DC modulating unit 22 also includes the first inbound side waveguide 51, the first folded waveguide 52, the outbound side waveguide 53, the second folded waveguide 54, and the second inbound side waveguide 55. The second DC modulating unit 22 includes the heater electrode 32 that is arranged parallel to the outbound side waveguide 53 so as to sandwich both side surfaces of the outbound side waveguide 53 included in the second waveguide 21. The first parallel electrode 35A included in the second DC modulating unit 22 is arranged parallel to both of the first inbound side waveguide 51 and the first heater electrode 32A so as to sandwich the first inbound side waveguide 51 with the first heater electrode 32A. The second parallel electrode 35B included in the second DC modulating unit 22 is arranged parallel to both of the second inbound side waveguide 55 and the second heater electrode 32B so as to sandwich the second inbound side waveguide 55 with the second heater electrode 32B.

The second DC modulating unit 22 includes the two heater electrodes 32 that are parallel to both side surfaces of the outbound side waveguide 53, and the first parallel electrode 35A that is arranged parallel to the outer side of the first inbound side waveguide 51 that is arranged parallel to the outbound side waveguide 53. The second DC modulating unit 22 includes the second parallel electrode 35B that is arranged parallel to the outer side of the second inbound side waveguide 55 that is arranged parallel to the outbound side waveguide 53. As a result of this, even if a voltage is applied to the heater electrode 32, an electric field is not applied to the second waveguide 21 accordingly due to the first parallel electrode 35A and the second parallel electrode 35B. A DC drift does not occur as a result of an electric field not being applied to the second waveguide 21, so that it is possible to implement stable phase control due to the heater electrode 32.

The DC modulating unit according to the first embodiment includes the two heater electrodes 32 that are arranged parallel to both side surfaces of the outbound side waveguide 53, and the first parallel electrode 35A that is parallel to the outer side of the first inbound side waveguide 51 that is arranged parallel to the outbound side waveguide 53. The DC modulating unit includes the second parallel electrode 35B that is parallel to the outer side of the second inbound side waveguide 55 that is arranged parallel to the outbound side waveguide 53. As a result of this, even if a voltage is applied to the heater electrode 32, an electric field is not applied to the first waveguide 17B accordingly due to the first parallel electrode 35A and the second parallel electrode 35B. A DC drift does not occur as a result of an electric field not being applied to the first waveguide 17B, so that it is possible to implement stable phase control due to the heater electrode 32.

In addition, in the optical modulator 1 according to the first embodiment, a case has been described as an example in which the first parallel electrode 35A is arranged on a side surface of the first inbound side waveguide 51, and the second parallel electrode 35B is arranged on a side surface of the second inbound side waveguide 55. However, the same effect is able to be obtained even if a heater electrode is arranged on one of the side surfaces of a single optical waveguide, and a parallel electrode is arranged on the other of the side surfaces of the single optical waveguide. For example, the heater electrode 32 may be arrange only on one of the side surfaces of the first inbound side waveguide 51, and the parallel electrode 35 may be arranged only on the other of the side surfaces of the first inbound side waveguide 51. As a result of this, even if a voltage is applied to the heater electrode 32, an electric field is not applied to the first inbound side waveguide 51 accordingly due to the parallel electrode 35. A DC drift does not occur as a result of an electric field not being applied to the first inbound side waveguide 51, so that it is possible to implement stable phase control due to the heater electrode 32. Furthermore, as a single optical waveguide, the first inbound side waveguide 51 has been exemplified, but the waveguide does not need to have a folded structure, and appropriate modifications are possible.

In addition, in the DC modulating unit according to the first embodiment, a case has been described as an example in which the portion between the input end of the parallel electrode 35 and the input end 321 of the heater electrode 32 is electrically connected, and the portion between the output end of the parallel electrode 35 and the output end 322 of the heater electrode 32 is electrically connected. The input end 321 is located in the vicinity of the input end of the heater electrode 32, whereas the output end 322 is located in the vicinity of the output end of the heater electrode 32. However, the embodiment is not limited to this, and an embodiment thereof will be described as a second embodiment below. In addition, by assigning the same reference numerals to components having the same configuration as those in the first DC modulating unit 19 according to the first embodiment, overlapped descriptions of the configuration and the operation thereof will be omitted.

### (b) Second Embodiment

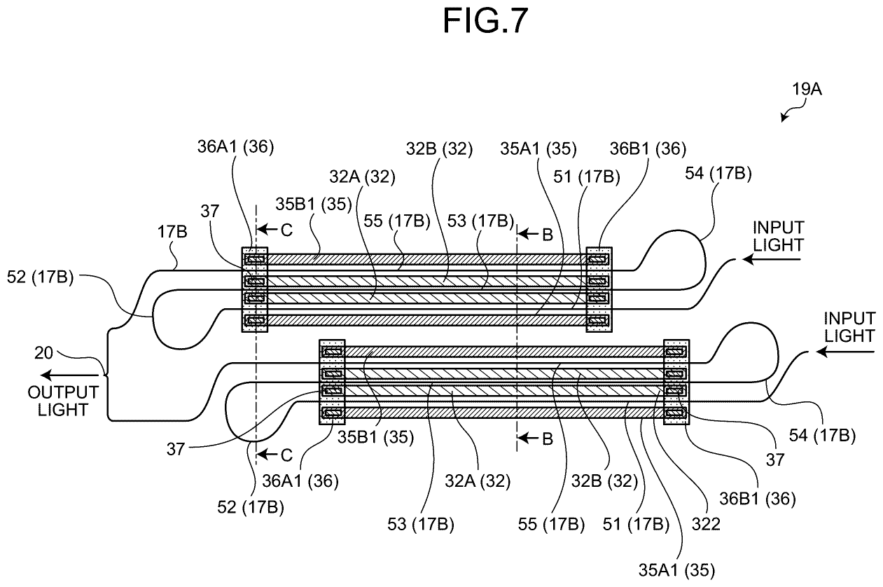

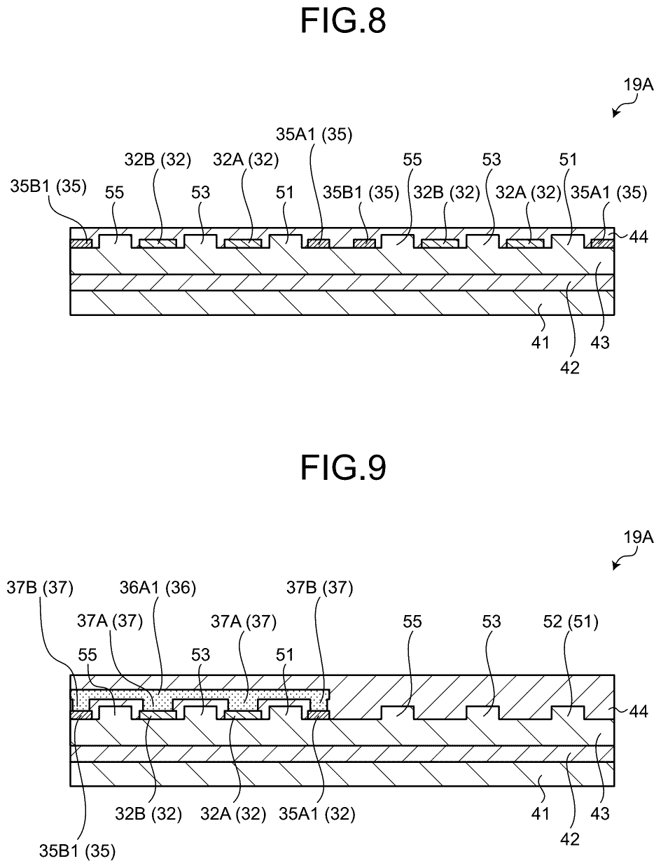

FIG. 7 is a schematic plan view illustrating one example of a first DC modulating unit 19A according to the second embodiment, FIG. 8 is a cross-sectional schematic diagram of one example of a cross-sectional view taken along line B-B illustrated in FIG. 7, and FIG. 9 is a cross-sectional schematic diagram of one example of a cross-sectional view taken along line C-C illustrated in FIG. 7. A first DC modulating unit 19A according to the second embodiment is different from the first DC modulating unit 19 according to the first embodiment in that an input end of the parallel electrode 35 and the input end 321 of the heater electrode 32 are electrically connected at a first electrode pad 36A1. Furthermore, the first DC modulating unit 19A is further different from the first DC modulating unit 19 in that an output end of the parallel electrode 35 and the output end 322 of the heater electrode 32 are electrically connected at a second electrode pad 36B1.

The parallel electrode 35 includes a first parallel electrode 35A1 and a second parallel electrode 35B1. The first electrode pad 36A1 is electrically connected to the input end 321 of the heater electrode 32 by way of a first via 37A, and is electrically connected to the input end of the parallel electrode 35 by way of a second via 37B. The second electrode pad 36B1 is electrically connected to the output end 322 of the heater electrode 32 by way of the first via 37A, and is electrically connected to the output end of the parallel electrode 35 by way of the second via 37B.

The first DC modulating unit 19A includes the two heater electrodes 32 that are arranged parallel to both side surfaces of the outbound side waveguide 53, and the first parallel electrode 35A1 that is arranged parallel to the outer side of the first inbound side waveguide 51 that is arranged parallel to the outbound side waveguide 53. The first DC modulating unit 19A includes the second parallel electrode 35B1 that is arranged parallel to the outer side of the second inbound side waveguide 55 that is arranged parallel to the outbound side waveguide 53. As a result of this, even if a voltage is applied to the heater electrode 32, an electric field is not applied to the first waveguide 17B accordingly due to the first parallel electrode 35A1 and the second parallel electrode 35B1. A DC drift does not occur as a result of an electric field not being applied to the first waveguide 17B, so that it is possible to implement stable phase control due to the heater electrode 32.

The second DC modulating unit 22 includes the two heater electrodes 32 that are arranged parallel to both side surfaces of the outbound side waveguide 53, and the first parallel electrode 35A1 that is arranged parallel to the outer side of the first inbound side waveguide 51 that is arranged parallel to the outbound side waveguide 53. The second DC modulating unit 22 includes the second parallel electrode 35B1 that is arranged parallel to the outer side of the second inbound side waveguide 55 that is arranged parallel to the outbound side waveguide 53. As a result of this, even if a voltage is applied to the heater electrode 32, an electric field is not applied to the second waveguide 21 accordingly due to the first parallel electrode 35A1 and the second parallel electrode 35B1. A DC drift does not occur as a result of an electric field not being applied to the second waveguide 21, so that it is possible to implement stable phase control due to the heater electrode 32.

In addition, in the first DC modulating unit 19 according to the first embodiment, a case has been described as an example in which the parallel electrode 35 is constituted by the material that is different from that of the heater electrode 32, but the embodiment is not limited to this, and an embodiment thereof will be described as a third embodiment below. In addition, by assigning the same reference numerals to components having the same configuration as those in the first DC modulating unit 19 according to the first embodiment, overlapped descriptions of the configuration and the operation thereof will be omitted.

### (c) Third Embodiment

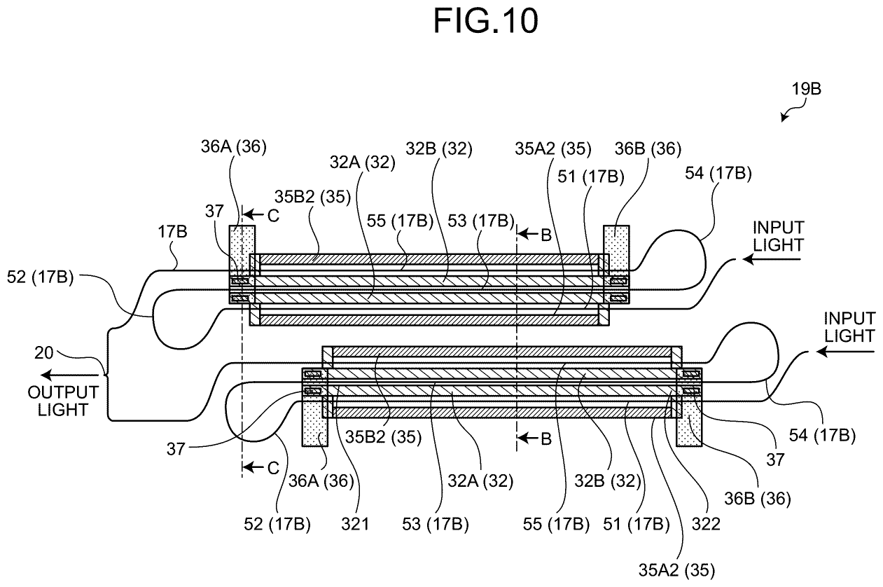

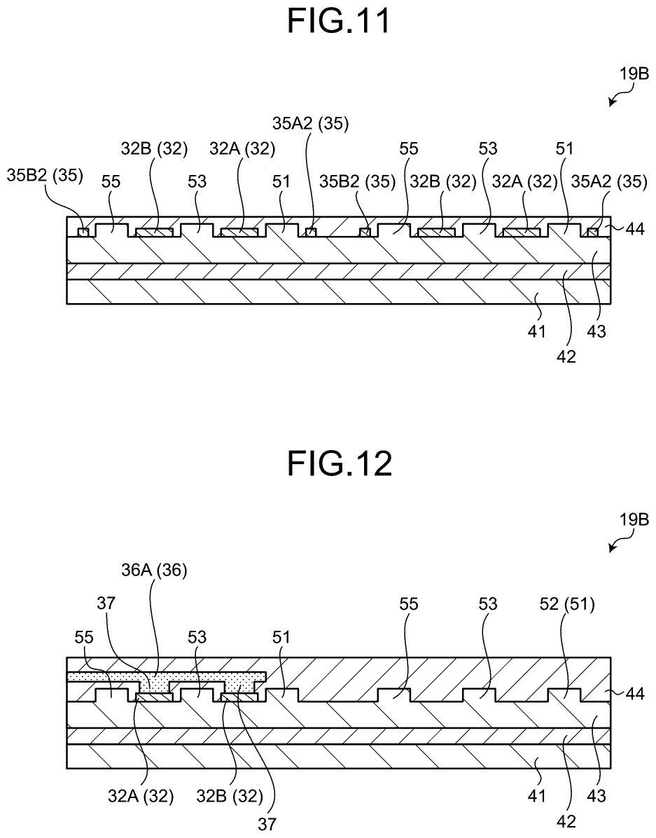

FIG. 10 is a schematic plan view illustrating one example of a first DC modulating unit 19B according to the third embodiment, FIG. 11 is a cross-sectional schematic diagram of one example of a cross-sectional view taken along line B-B illustrated in FIG. 10, and FIG. 12 is a cross-sectional schematic diagram of one example of a cross-sectional view taken along line C-C illustrated in FIG. 10. The first DC modulating unit 19B according to the third embodiment is different from the first DC modulating unit 19 according to the first embodiment in that, the same material as that used for the heater electrode 32 is used for the parallel electrode 35, but the parallel electrode 35 is constituted to have high resistance as a result of the width of the parallel electrode 35 being made narrower than the width of the heater electrode 32.

The parallel electrode 35 includes a first parallel electrode 35A2 and a second parallel electrode 35B2. The electrode width of the first parallel electrode 35A2 is made narrower than the electrode width of the heater electrode 32, so that the first parallel electrode 35A2 has high resistance accordingly. The electrode width of the second parallel electrode 35B2 is made narrower than the electrode width of the heater electrode 32, so that the second parallel electrode 35B2 has high resistance accordingly.

The first DC modulating unit 19B includes the two heater electrodes 32 that are arranged parallel to both side surfaces of the outbound side waveguide 53, and the first parallel electrode 35A2 that is arranged parallel to the outer side of the first inbound side waveguide 51 that is arranged parallel to the outbound side waveguide 53. The first DC modulating unit 19B includes the second parallel electrode 35B2 that is arranged parallel to the outer side of the second inbound side waveguide 55 that is arranged parallel to the outbound side waveguide 53. As a result of this, even if a voltage is applied to the heater electrode 32, an electric field is not applied to the first waveguide 17B accordingly due to the first parallel electrode 35A2 and the second parallel electrode 35B2. A DC drift does not occur as a result of an electric field not being applied to the first waveguide 17B, so that it is possible to implement stable phase control due to the heater electrode 32.

The second DC modulating unit 22 includes the two heater electrodes 32 that are arranged parallel to both side surfaces of the outbound side waveguide 53, and the first parallel electrode 35A2 that is arranged parallel to the outer side of the first inbound side waveguide 51 that is arranged parallel to the outbound side waveguide 53. The second DC modulating unit 22 includes the second parallel electrode 35B2 that is arranged parallel to the outer side of the second inbound side waveguide 55 that is arranged parallel to the outbound side waveguide 53. As a result of this, even if a voltage is applied to the heater electrode 32, an electric field is not applied to the second waveguide 21 due to the first parallel electrode 35A2 and the second parallel electrode 35B2. A DC drift does not occur as a result of an electric field not being applied to the second waveguide 21, so that it is possible to implement stable phase control due to the heater electrode 32.

In the optical modulator 1 according to the third embodiment, the parallel electrode 35 is constituted by the same material as that of the heater electrode 32, which makes it possible to simplify a manufacturing process.

Furthermore, the embodiment is not limited to the electrode width of the parallel electrode 35, but the thickness of the parallel electrode 35 may be made thinner than the thickness of the heater electrode 32, and appropriate modifications are possible.

In addition, in the first DC modulating unit 19 according to the first embodiment, a case has been described as an example in which the parallel electrode 35 is constituted to have the material that is different from that of the heater electrode 32, but the embodiment is not limited to this, and an embodiment thereof will be described as a third embodiment below. In addition, by assigning the same reference numerals to components having the same configuration as those in the first DC modulating unit 19 according to the first embodiment, overlapped descriptions of the configuration and the operation thereof will be omitted.

### (d) Fourth Embodiment

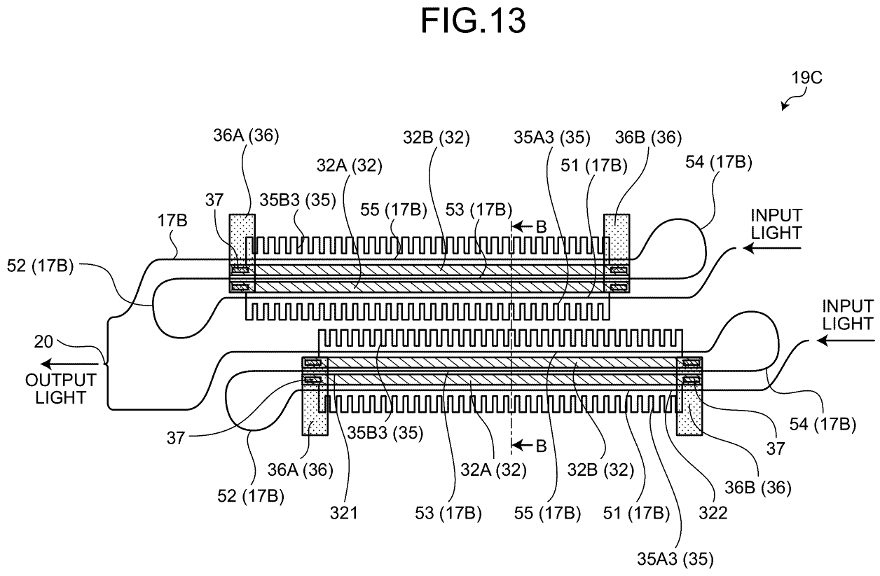

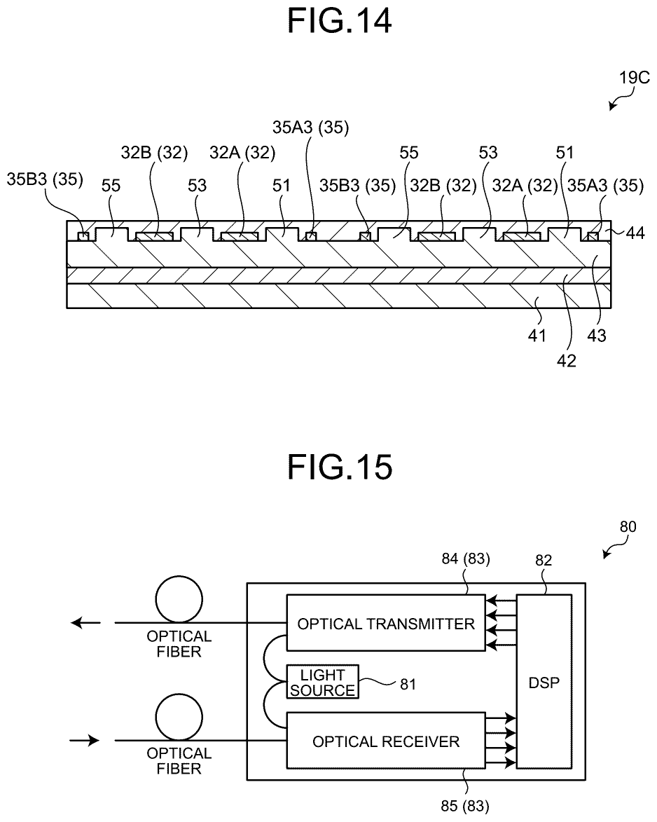

FIG. 13 is a schematic plan view illustrating one example of a first DC modulating unit according to the fourth embodiment, and FIG. 14 is a cross-sectional schematic diagram of one example of a cross-sectional view taken along line B-B illustrated in FIG. 13. A first DC modulating unit 19C according to the fourth embodiment is different from the first DC modulating unit 19 according to the first embodiment in that the parallel electrode 35 is constituted by the same material as that used for the heater electrode 32, and an electrode length of the heater electrode 32 is made longer than an electrode length of the parallel electrode 35, so that the parallel electrode 35 has high resistance.

The parallel electrode 35 includes a first parallel electrode 35A3 and a second parallel electrode 35B3. The first parallel electrode 35A3 is arranged in a meandering manner in the range of the same electric potential as that of the first heater electrode 32A that is adjacent to the first inbound side waveguide 51. The second parallel electrode 35B3 is arranged in a meandering manner in the range of the same electric potential as that of the second heater electrode 32B that is adjacent to the second inbound side waveguide 55.

The first DC modulating unit 19C includes the two heater electrodes 32 that are arranged parallel to both side surfaces of the outbound side waveguide 53, and the first parallel electrode 35A3 that is arranged parallel to the outer side of the first inbound side waveguide 51 that is arranged parallel to the outbound side waveguide 53. The first DC modulating unit 19C includes the second parallel electrode 35B3 that is arranged parallel to the outer side of the second inbound side waveguide 55 that is arranged parallel to the outbound side waveguide 53. As a result of this, even if a voltage is applied to the heater electrode 32, an electric field is not applied to the first waveguide 17B accordingly due to the first parallel electrode 35A3 and the second parallel electrode 35B3. A DC drift does not occur as a result of an electric field not being applied to the first waveguide 17B, so that it is possible to implement stable phase control due to the heater electrode 32.

The second DC modulating unit 22 includes the two heater electrodes 32 that are arranged parallel to both side surfaces of the outbound side waveguide 53, and the first parallel electrode 35A3 that is arranged parallel to the outer side of the first inbound side waveguide 51 that is arranged parallel to the outbound side waveguide 53. The second DC modulating unit 22 includes the second parallel electrode 35B3 that is arranged parallel to the outer side of the second inbound side waveguide 55 that is arranged parallel to the outbound side waveguide 53. As a result of this, even if a voltage is applied to the heater electrode 32, an electric field is not applied to the second waveguide 21 accordingly due to the first parallel electrode 35A3 and the second parallel electrode 35B3. A DC drift does not occur as a result of an electric field not being applied to the second waveguide 21, so that it is possible to implement stable phase control due to the heater electrode 32.

Furthermore, in the present embodiment, the DC modulating unit that is included in the optical modulator 1 and that uses the heater electrodes 32 has been described as an example, but the embodiment is not limited to this, and the embodiment is applicable to a phase shifter, an optical device, such as a VOA, that uses the heater electrodes 32.

FIG. 15 is an explanation diagram illustrating one example of an optical transceiver 80 according to the present embodiment. The optical transceiver 80 illustrated in FIG. 15 is connected to an optical fiber provided on the output side and an optical fiber provided on an input side. The optical transceiver 80 includes a light source 81, a digital signal processor (DSP) 82, and an optical transmitter/receiver 83. The optical transmitter/receiver 83 includes an optical transmitter 84 and an optical receiver 85. The DSP 82 is an electrical component that performs digital signal processing. The DSP 82 performs a process of encoding, for example, transmission data or the like, generates an electrical signal including transmission data, and outputs the generated electrical signal to the optical transmitter 84. In addition, the DSP 82 acquires an electrical signal including reception data from the optical receiver 85, and obtains reception data by performing a process of decoding the acquired electrical signal.

The light source 81 includes, for example, a laser diode or the like, generates light at a predetermined wavelength, and supplies the generated light to the optical transmitter 84 and the optical receiver 85. The optical transmitter 84 is an optical device, such as an optical modulator, that modulates light supplied from the light source 81 by using the electrical signal that is output from the DSP 82, and that outputs the modulated signal light to the optical fiber. The optical transmitter 84 includes therein, as a built-in element, an optical device, such as an optical modulator, that includes, for example, the first DC modulating unit 19, the second DC modulating unit 22, and the like. The optical transmitter 84 generates signal light by modulating, when the light supplied from the light source 81 is guided through the waveguide, the light by using the electrical signal.

The optical receiver 85 receives reception light from the optical fiber, converts the reception light to an electrical signal by using the light that is supplied from the light source 81, and outputs the converted electrical signal to the DSP 82.

A case has been described as an example in which the optical transceiver 80 includes therein, as a built-in element, the optical transmitter 84 and the optical receiver 85, but the example is applicable to an optical transmitter that includes therein, as a built-in element, only the optical transmitter 84 that includes therein, as a built-in element, an optical device. Furthermore, the embodiment is also applicable to an optical receiver that includes therein, as a built-in element, only the optical receiver 85 that includes therein, as a built-in element, an optical device. Furthermore, the embodiment is not limited to the optical transceiver 80, the optical device is also applicable to the optical transmitter/receiver 83.

In the present embodiment, the thin film LN chip has been described as an example, but the embodiment is not limited to this. For example, TF-Barium Titanate may also be used, and appropriate modifications are possible. A material for the electro-optical effect used may be, for example, TF-BTO (BaTiO₃), TF-PLZT (PbLaZrTiO₃), or TF-PZT (PbZrTiO₃), and appropriate modifications are possible.

According to an aspect of an embodiment of the optical device and the like disclosed in the present application, it is possible to reduce a loss of light caused by a heater electrode.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a waveguide in which light is guided and that has electro-optical effect and thermo-optical effect;
a heater electrode that is arranged on one of side surfaces of the waveguide and that heats the waveguide; and
a parallel electrode that is arranged on the other of the side surfaces of the waveguide, that is electrically connected to the heater electrode, and that has high resistance as compared with the heater electrode.

2. The optical device according to claim 1, wherein the parallel electrode electrically connects a portion between an input end of the parallel electrode and an input end of the heater electrode, and electrically connects a portion between an output end of the parallel electrode and an output end of the heater electrode.

3. The optical device according to claim 1, wherein the parallel electrode includes a material that is different from a material used for the heater electrode.

4. The optical device according to claim 1, wherein the parallel electrode is constituted by the same material as that used for the heater electrode, and has a structure in which an electrode width of the parallel electrode is made narrower than an electrode width of the heater electrode.

5. The optical device according to claim 1, wherein the parallel electrode is constituted by the same material as that used for the heater electrode, and has a meandering structure in which an electrode length of the parallel electrode is made longer than an electrode length of the heater electrode.

6. The optical device according to claim 1, wherein
the waveguide includes
a first waveguide,
a second waveguide that is arranged parallel to the first waveguide, and
a third waveguide that is arranged parallel to the first waveguide and the second waveguide at a position between one of side surfaces of the first waveguide and one of side surfaces of the second waveguide,
the heater electrode includes
a first heater electrode that is arranged on one of side surfaces of the third waveguide, and
a second heater electrode that is arranged on the other of the side surfaces of the third waveguide, and
the parallel electrode includes
a first parallel electrode that is arranged on the other of the side surfaces of the first waveguide, and that is electrically connected to the first heater electrode, and
a second parallel electrode that is arranged on the other of the side surfaces of the second waveguide, and that is electrically connected to the second heater electrode.

7. The optical device according to claim 6, wherein
the waveguide includes
a first folded waveguide that connects a portion between an output end of the first waveguide and an input end of the third waveguide, and
a second folded waveguide that connects a portion between an output end of the third waveguide and an input end of the second waveguide.

8. An optical transmitter comprising:
a light source that emits light; and
an optical device that modulates the light received from the light source in accordance with an electrical signal, wherein
the optical device includes
a waveguide in which light is guided and that has electro-optical effect and thermo-optical effect,
a heater electrode that is arranged on one of side surfaces of the waveguide and that heats the waveguide, and
a parallel electrode that is arranged on the other of the side surfaces of the waveguide, that is electrically connected to the heater electrode, and that has high resistance as compared with the heater electrode.

9. An optical receiver comprising:
a light source that emits light; and
an optical device that converts, by using the light emitted from the light source, from reception light to an electrical signal, wherein
the optical device includes
a waveguide in which light is guided and that has electro-optical effect and thermo-optical effect,
a heater electrode that is arranged on one of side surfaces of the waveguide and that heats the waveguide, and
a parallel electrode that is arranged on the other of the side surfaces of the waveguide, that is electrically connected to the heater electrode, and that has high resistance as compared with the heater electrode.
